(19) United States
(12) Patent Application Publication
(10) Pub. No.: US 2017/0230231 A1
(43) Pub. Date: Aug. 10, 2017

(54) REOFREDUNDANCY SYSTEM BASED ON VIRTUAL ROUTER REDUNDANCY PROTOCOL AND METHOD THEREOF

(71) Applicant: MOXA INC., New Taipei City (TW)

(72) Inventors: Kuo-Wei HSU, New Taipei City (TW); Chih-Chiang LAI, New Taipei City (TW); Shih-Chia YEN, New Taipei City (TW); Wen-Che HSU, New Taipei City (TW); Chien-Yu LAI, New Taipei City (TW)

(21) Appl. No.: 15/017,640

(22) Filed: Feb. 7, 2016

(51) Int. Cl. H04L 12/24; H04L 12/46

(52) U.S. Cl. CPC H04L 41/0654; H04L 12/4641

(57) ABSTRACT

In one embodiment of the invention, a redundancy system/method based on the Virtual Router Redundancy Protocol, it includes a master router and at least one backup router preselected. The master router and at least one backup router may have a weight value and Virtual LANs composed of same routing path. A communication representative is chosen from one of the Virtual LANs of each of the master router and the backup router. The communication representative of the master router may continuously transmit the advertisement packet to that of the backup router, and continuously transmit an Address Resolution Protocol table to the backup router. When a communication representative of the backup router doesn't receive the advertisement packet, all the Virtual LANs of the master router will be judged abnormal, and the master router may be replaced, therefore enhance the redundancy switching efficiency and increase the number of the available Virtual LANs.

### BACKGROUND OF RELATED ARTS

1. Technical Field

The present invention relates to a redundancy system and method thereof, and more particularly to a redundancy system based on the Virtual Router Redundancy Protocol and method thereof which may reduce the time interval of transmitting advertisement packets and the number of transmitting the advertisement packets to the Virtual LANs.

2. Background Arts

Recently, the industry control has strict demands over the network stability. In practice, the stability and the reliability of the network usually may be realized by going with a redundancy mechanism.

Generally, for the reliability for the network, the router may perform the VRRP (Virtual Router Redundancy Protocol), which regards a plurality of routers as a virtual router, and then chooses one of the routers to be a master router and the others to be backup routers. As a result, when the master router is abnormal, it may be replaced by the backup router. Besides, the abnormal detection in prior arts is represented here. Traditionally, the master router may transmit advertisement packets to the backup router continuously. When the backup router does not receive the advertisement packet, the master router is considered an abnormality. However, the replacement process may take much time relatively. For example, the replacement process for VRRP needs three seconds at least, so the redundancy replacement process may lead into a poor performance.

In view of this, some companies propose an approach to improve the performance of the redundancy replacement process by shortening the time interval of transmitting the advertisement packets. However, this approach still needs to transmit the advertisement packets to each Virtual LAN. Because the consideration for the bandwidth and the time for transmitting the advertisement packets, the number of the available Virtual LANs will be limited. Therefore, the problem of the limited number of the available Virtual LANs is still existed after improving the performance of the redundancy replacement process.

In summary, the poor performance of the redundancy replacement process and the limited number of the available Virtual LANs are existed in the prior arts for a long time. As a result, there is necessary to propose an improved technical means to overcome the problem.

### SUMMARY

The present invention discloses a redundancy system based on the Virtual Router Redundancy Protocol and method thereof.

The first objective of the present invention is to provide a redundancy system based on the Virtual Router Redundancy Protocol for a plurality of routers in the internet. The redundancy system includes an initialization module, a selection module, a transmission module and a redundancy module. The initialization module is configured to choose a master router and at least one backup router from the routers in advance, and the master router and the at least one backup router have a weight value and one Virtual LANs (Virtual Local Area Network) composed of the same routing path. The selection module is configured to choose one of the Virtual LANs of each of the master router and the at least one backup router to be communication representatives. The transmission module is configured to make the communication representative of the master router to transmit the advertisement packet to that of the at least one backup router in a first time interval continuously and transmit an Address Resolution Protocol table to the at least one backup router in a second time interval continuously. When the advertisement packet of the master router is not received by the communication representative of the at least one backup router in a third time interval, the redundancy module judges that all the Virtual LANs of the master router are abnormal and reselect one of the at least one backup router to replace the master router according to the weight value thereof.

The second objective of the present invention is to provide a redundancy method based on the Virtual Router Redundancy Protocol used for a plurality of routers in the internet, and the method includes following steps: choosing a master router and at least one backup router from the routers, and the master router and the at least one backup router having a weight value and at least one Virtual LAN (Virtual Local Area Network) composed of the same routing path; choosing one of the at least one Virtual LAN of each of the master router and the at least one backup router to be corresponding communication representatives; transmitting an advertisement packet from the communication representative of the master router to that of the at least one backup router in a first time interval continuously and transmitting an Address Resolution Protocol table to the at least one backup router in a second time interval continuously; and judging that all the Virtual LANs of the master router are abnormal and reselecting one of the at least one backup router to replace the master router according to the weight value thereof when the advertisement packet transmitted from the master router is not received by that of the at least one backup router in a third time interval.

The aforesaid descriptions disclose the system and method of the present invention. The major difference between the present invention and the prior arts is that the present invention chooses the master router and the backup routers from all the routers, and the master router and the backup routers have the weight value and the at least one Virtual LAN composed of the same routing path and the communication representatives are chosen from the Virtual LANs of each of the master router and the backup routers. The communication representative of the master router may transmit the advertisement packet to the one of each of the backup routers and transmit an Address Resolution Protocol table to the backup routers continuously. When the communication representatives of the backup routers do not receive the advertisement packet, all the Virtual LANs of the master router are judged as abnormal and the master router may be replaced.

By the above technical means, the present invention may enhance the performance of the redundancy replacement process and increase the number for the available Virtual LANs.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a redundancy system based on the Virtual Router Redundancy Protocol of the present invention.

FIG. 2 is a flow chart of a redundancy method based on the Virtual Router Redundancy Protocol of the present invention.

FIG. 3 is a flow chart of a redundancy method based on the Virtual Router Redundancy Protocol according to another embodiment of the present invention.

FIG. 4 is a view of taking the routers as the router and the backup router of the present invention.

FIG. 5 is a view of transmitting an advertisement packet and an Address Resolution Protocol table of the present invention.

FIG. 6 is a view of a redundancy system used in a linear network of present invention.

### DETAILED DESCRIPTION

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

The environment applied to the present invention is described first before disclosing the redundancy system based on the Virtual Router Redundancy Protocol and method thereof. The network which is applied by the routers of the present invention is not limited to a specific type. As long as the setting for the Virtual LAN of the port of the router is the same, the present invention will not be limited to use in the ring network or the linear network. In an embodiment, these routers may be regarded as a virtual router which uses a virtual IP to provide a routing service. And, only one router of these routers may be a master router, and the others are the backup routers. When the master router is broken down, one of the backup routers will replace the master router, so as to provide the service continuously. This mechanism can be achieved by the Virtual Router Redundancy Protocol. Preferably, the ring network may further connect to a chain network capable of handling a redundancy processing. The chain network has a head switch and a tail switch, where the head switch connects to the ring network at a head port thereof and the tail switch connects to the ring network at a tail port thereof.

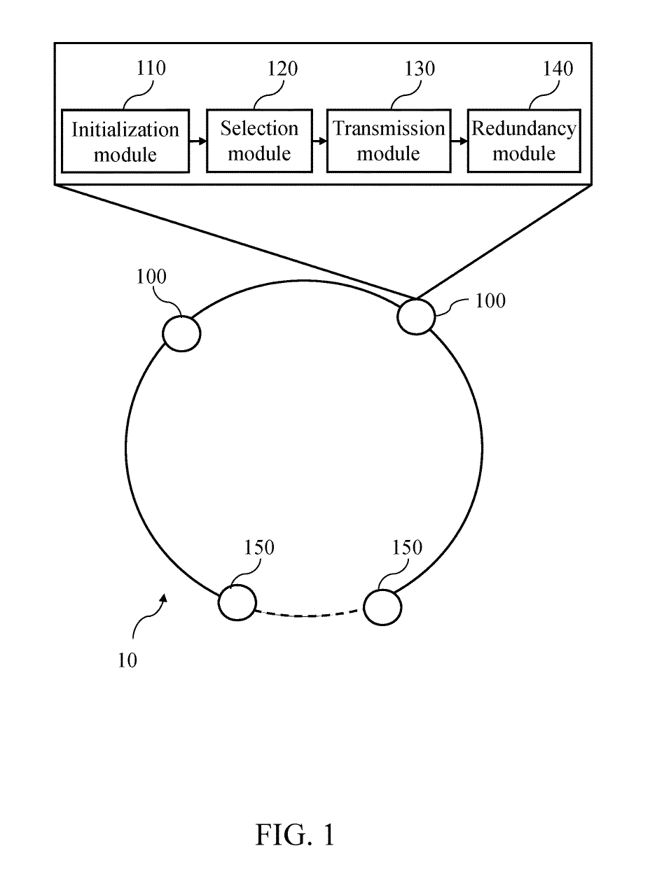

Reference will now be made in detail to the redundancy system based on the Virtual Router Redundancy Protocol and method thereof of the present invention, examples of which are illustrated in the accompanying drawings. Please refer to FIG. 1, which is a block diagram of a redundancy system based on the Virtual Router Redundancy Protocol of the present invention. The redundancy system may be applied to a network environment (such as a ring network 10) and include an initialization module 110, a selection module 120, a transmission module 130 and a redundancy module 140. The initialization module 110 may first choose a master router and at least one backup router from the routers in advance. The master router and the at least one backup router have a weight value and at least one Virtual LAN (Virtual Local Area Network) composed of the same routing path. Assume that there are two routers 100, and the first router 100 includes a weight value [symbol] 100 [symbol] and a plurality of Virtual LANs with the same path, and the name of each of the Virtual LANs is [symbol] V1 [symbol] , [symbol] V2 [symbol] and [symbol] V3 [symbol] . The second router 100 includes a weight value [symbol] 254 [symbol] and a plurality of Virtual LANs with the same path, where the name of each of the Virtual LANs is [symbol] V1 [symbol] , [symbol] V2 [symbol] and [symbol] V3 [symbol] as well. At this time, the initialization module 110 may choose a master router and a backup router from the routers 100 by the weight values thereof. For example, the second router 100 with a large weight value may be the master router, and the first router 100 with a small weight value may be a backup router. It is worth to be mentioned, except the routers 100, the ring network 10 may further include others network communication devices, including two switches 150.

The selection module 120 may choose one of the Virtual LANs of each of the master router and the backup router to be corresponding communication representatives. In an embodiment, the mechanism of choosing the communication representative may be implemented by a preset. Take the above description for example, the first Virtual LAN, such as the Virtual LAN [symbol] V1 [symbol] , may be set as the communication representative in advance, so as to express all the Virtual LANs of the router, such as the Virtual LANs [symbol] V2 [symbol] and [symbol] V3 [symbol] . Because all the Virtual LANs have the same routing path, when one of the Virtual LAN is abnormal, it indicates that all the Virtual LANs are abnormal. As a result, the communication representative of the master router is the Virtual LAN whose name is [symbol] V1 [symbol] , and the communication representative of the backup router is the Virtual LAN whose name is [symbol] V1 [symbol] as well. Further, the communication representative of the master router is regarded as “Master” and the communication representatives of all backup routers are regarded as “Backup”.

The transmission module 130 makes the communication representative of the chosen master router transmit the advertisement packet to the communication representative of the backup router in a first time interval continuously, for example, the advertisement packet may be transmitted every 25 milliseconds, and transmit the ARP (Address Resolution Protocol) table to the backup router in a second time interval continuously, for example, the ARP table is transmitted every 10 seconds. Because only the communication representative of the master router may transmit the advertisement packet to the backup router, the number of transmitting the advertisement packet may be reduced effectively (traditionally, when there are lots of Virtual LANs, each backup Virtual LAN will receive the advertisement packet transmitted from the master router.). Besides, since the master router transmits the ARP table to the backup router continuously, only one router 100 is used in creating a routing table for others routers 100, so as to save the time of creating the routing table and the bandwidth occupied when creating the routing table.

When the advertisement packet of the master router is not received by the communication representative of the backup router in a third time interval, take 75 milliseconds for example, the redundancy module 140 judges that all the Virtual LANs of the master router are abnormal and reselect one of the backup routers to replace the master router according to the weight value thereof. For example, when a judgment for all the Virtual LANs of the master router is abnormal, a backup router with a largest weight value is chosen and it may replace the original master router. In an embodiment, the third time interval may be a multiple of the first time interval. Besides, when the advertisement packet of the master router is received by the communication representative of the backup router in the third time interval, the redundancy module 140 may further make the selection module 120 reselect the other communication representative or sustain to use the current communication representative according to a parameter of the advertisement packet. For example, it is assumed that the value of the parameter is “1”, and the selection module may reselect the other communication representative; or, it is assumed that the value of the parameter is “0”, and the selection module may sustain to use the current communication representative.

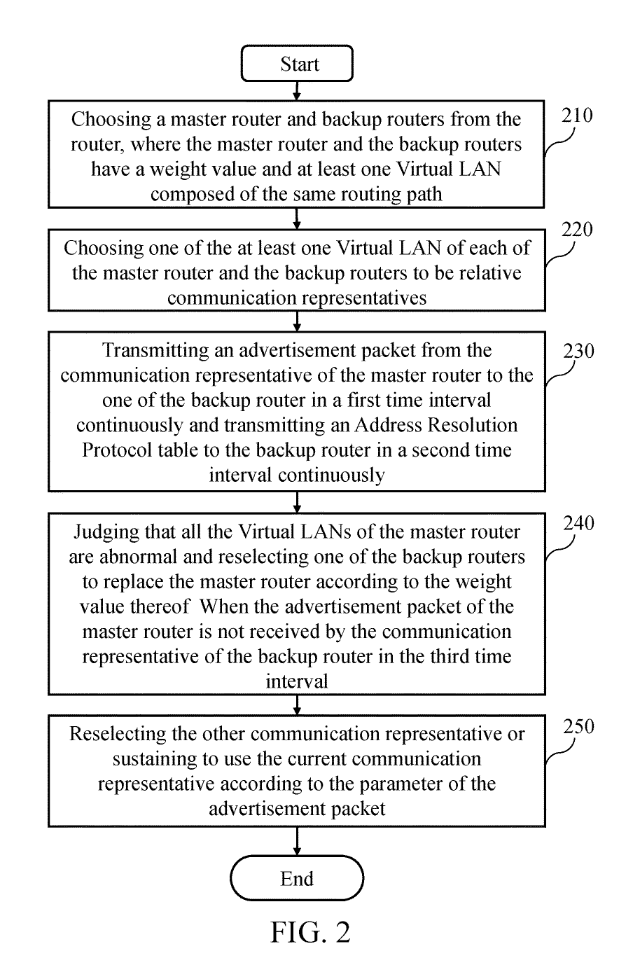

Next, please refer to FIG. 2, which is a flow chart of a redundancy method based on the Virtual Router Redundancy Protocol of the present invention. The redundancy method may be applied to a network environment with a plurality of routers 100, for example, a ring network 10, and may include steps as below. In a step 210, a master router and backup routers are chosen from the routers 100, and the master router and the backup routers have a weight value and at least one Virtual LAN (Virtual Local Area Network) composed of the same routing path. In a step 220, one of the Virtual LANs of each of the master router and the backup routers is chosen to be relative communication representatives. In a step 230, an advertisement packet from the communication representative of the master router is transmitted to the one of the backup router in a first time interval continuously and transmitting an Address Resolution Protocol table to the backup router in a second time interval continuously. When the advertisement packet of the master router is not received by the communication representative of the backup router in the third time interval, in a step 230 it is judged that all the Virtual LANs of the master router are abnormal and reselecting one of the backup routers to replace the master router according to the weight value thereof. By the above steps, the master router and the backup routers from all the routers 100 may be chosen in advance. The master router and the backup routers may have the weight value and the Virtual LANs composed of the same routing path, and the communication representatives are chosen from the Virtual LANs of each of the master router and the backup routers. Thus, the communication representative of the master router may transmit the advertisement packet to that of each of the backup routers and transmit the ARP table to the backup routers continuously. When the communication representatives of the backup routers do not receive the advertisement packet, all the Virtual LANs of the master router are judged as abnormal and the master router is replaced. It's worth to be mentioned, in the embodiment, the step 210 and the step 220 may not be ordered in time sequence. In other words, because the ports of the routers have the same setting, the master router and the backup routers may be chosen after one of the Virtual LANs of the routers is chosen respectively to be the corresponding communication representative.

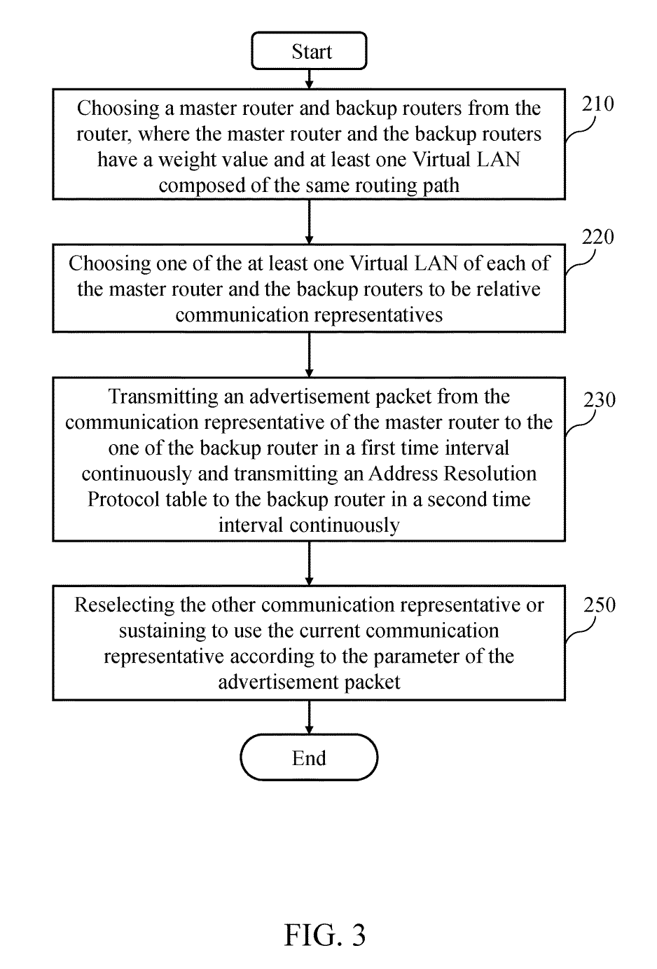

Next, please refer to FIG. 3, which is a flow chart of a redundancy method based on the Virtual Router Redundancy Protocol according to another embodiment of the present invention. The flow chart is similar to that of FIG. 2, but the major difference is steps after the step 230. When the advertisement packet of the master router is received by the communication representative of the backup router in the third time interval, in a step 250 the other communication representative or sustaining is reselected to use the current communication representative according to the parameter of the advertisement packet. For example, it is assumed that the parameter is [symbol] T; 2 [symbol] , where “T” indicates that the other communication representative may need to be reselected, and “2” indicates that the second Virtual LAN may be set as the communication representative. It is assumed that the parameter is “F”, and the selection module may sustain to use the current communication representative.

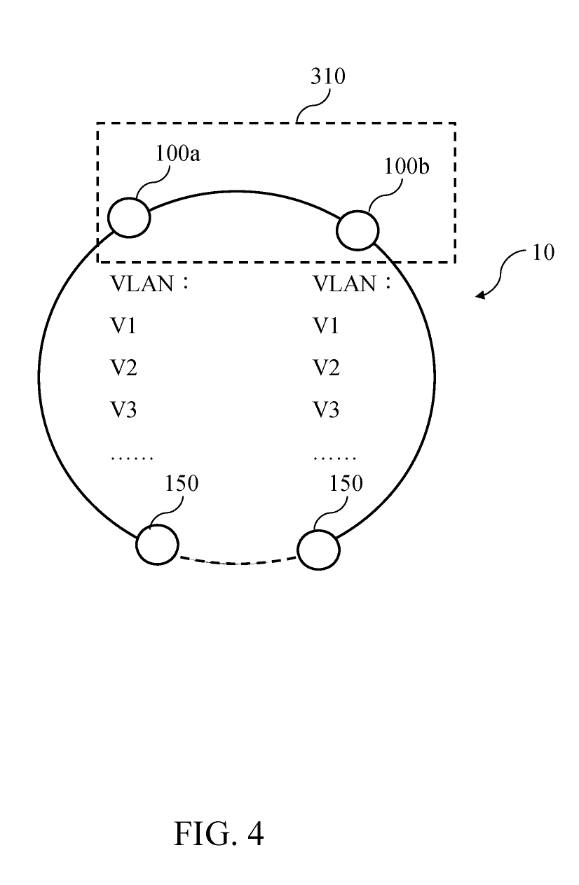

FIG. 4 to FIG. 6 show example of embodiments illustrated of the present invention. Please refer to FIG. 4, which is a view of taking the routers as the router and the backup router of the present invention. In this embodiment, there are two routers 100a and 100b, and a plurality of switches 150 in the ring network 10 of the present invention. Each of the two routers 100a and 100b may have a physical IP correspondingly, and they may be regarded as a virtual router 310 with a virtual IP correspondingly. For the switches 150, they can communicate with the virtual router 310 by getting the virtual IP, and they do not need to know the physical IP of the routers 110a, 110b. In an embodiment, the fundamental setting for the virtual router 310 may be implemented by using the Virtual Router Protocol, and it may take the setting for the weight value and the Virtual LAN for example. The master router and the backup router may be chosen from the two routers 100a and 100b. For example, the router 100a is the master router and the router 100b is the backup router. The approach of choosing the master router and the backup router is based on the Virtual Router Protocol, so the repetitious details are omitted here.

Next, after the master router and the backup router are chosen, one the Virtual LANs, such as VLAN V1, V2, V3, . . . , of the master router, is chosen to be the communication representative of the master router, and one of the Virtual LANs, such as VLAN V1, V2, V3, . . . , of the backup router, is chosen to be the communication representative of the backup router. Then, the communication representative of the master router may transmit an advertisement packet to the backup router in a first time interval continuously, for example, every 25 milliseconds, to inform the backup router that the status of the master router is normal, and transmit the ARP table to the backup router in a second time interval continuously, for example, every 10 seconds, so as to save the time for regenerating the ARP table when the master router is replaced by the backup router.

In summary, when the advertisement packet of the master router is not received by the communication representative of the backup router in the third time interval, the master router is regarded as abnormal because the communication representative of the master router cannot transmit the advertisement packet normally. And, since all the Virtual LANs of the master router have the same routing path, it also means that all the Virtual LANs of the master router are abnormal when the communication representative of the master router is abnormal. Therefore, one of the backup routers is chosen to replace the master router according to the weight value thereof. For example, router 100b replaces the router 100a and the router 100b becomes the master router. It's worth to be mentioned, whether the master router is the router 100a or the router 100b in virtual router 310, it makes no difference for the switches 150 because the two routers are regarded as the identical router.

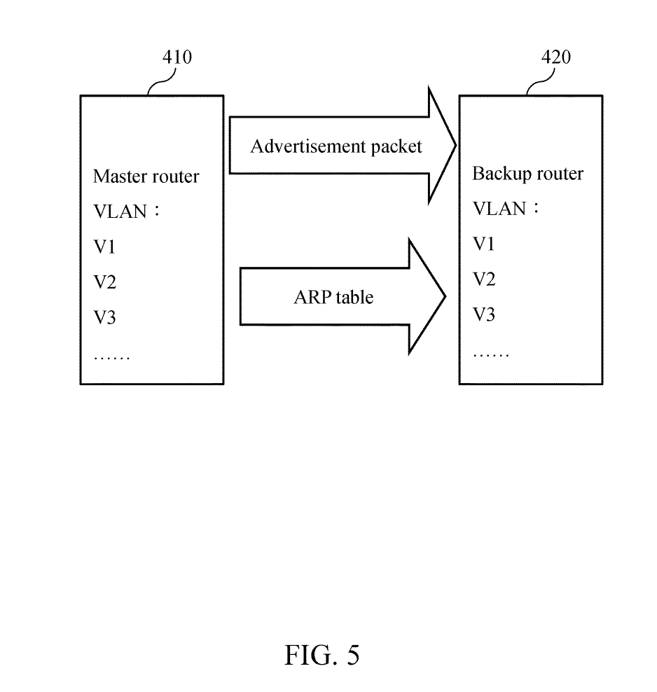

Please refer to FIG. 5, which is a view of transmitting an advertisement packet and an Address Resolution Protocol table of the present invention. Generally speaking, for the routers of the present invention and the routers based on the traditional Virtual Router Protocol, the major difference between them is the parts for transmitting the advertisement packets and the ARP table. As shown in FIG. 5, the master router 410 and the backup routers 420 do not respectively transmit the advertisement packets to each of the Virtual LANs, such as the VLAN V1, V2 and V3, and they transmit the advertisement packet to the communication representative of the backup router 420 instead, so as to reduce the number of transmitting the advertisement packets. Besides, in order to make the backup router 420 replace the abnormal master router 410 for a short time, the first time interval of transmit the advertisement packet may be adjusted from 1 second to 25 milliseconds. Next, to avoid to waste much time to learn and regenerate the ARP table after replacing the master router 410 by the backup router 420, the master router 410 may transmit the ARP table to the backup router 420 in the second time interval, for example, for every 10 seconds. As a result, the time of detecting the abnormal master router 410 and the time of restoring the system after replacing the master router 410 may be shorten, and the number of the available Virtual LANs may be increased.

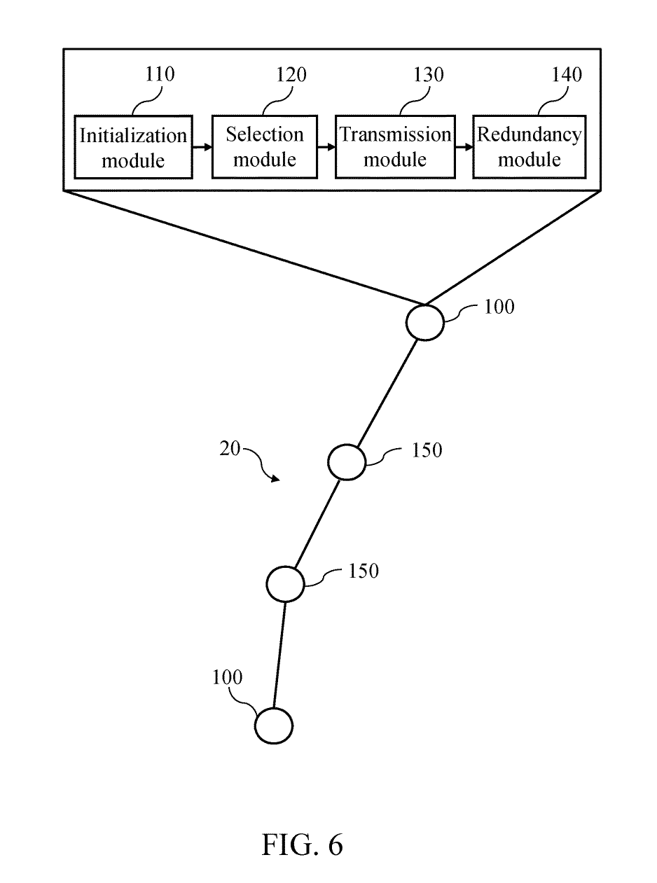

Please refer to FIG. 6, which is a view of a redundancy system used in a linear network of the present invention. As mentioned above, as long as the setting for the Virtual LAN of the port of the routers 100 is the same, either the ring network or the linear network may be used in the present invention. Thus, in an embodiment, the present invention not only applies to the ring network 10 shown in FIG. 1, but also apples to the linear network 20 shown in FIG. 6. In further, the linear network 20 may be composed of at least two routers 100 and a number of switches 150. It is worth to be mentioned, the router 100 of the present invention may be the Layer 3 Switch and the intermediate switch 150 may be the Layer 2 Switch.

In summary, the major difference between the present invention and the prior arts is that the present invention chooses the master router and the backup routers from all the routers in advance. The master router and the backup routers may have the weight value and at least one Virtual LAN composed of the same routing path, and a communication representative is chosen from the Virtual LANs of each of the master router and the backup routers. The communication representative of the master router may transmit the advertisement packet to that of each backup router and transmit an Address Resolution Protocol table to the backup router continuously. When the communication representative of the backup router does not receive the advertisement packet, all the Virtual LANs of the master router are judged as abnormal and the master router is replaced, The problem existed in the prior arts may solved by the technical means, so as to enhance the technical effect for the redundancy switching efficiency and increase the number for the available Virtual LANs.

The above-mentioned descriptions represent merely the exemplary embodiment of the present invention, without any intention to limit the scope of the present invention thereto. Various equivalent changes, alternations or modifications based on the claims of present invention are all consequently viewed as being embraced by the scope of the present invention.

What is claimed is:

1. A redundancy system based on the Virtual Router Redundancy Protocol used for a plurality of routers in a network environmental, the redundancy system comprising:
an initialization module, configured to choose a master router and at least one backup router from the routers in advance, wherein the master router and the at least one backup router comprise a weight value and at least one Virtual LAN (Virtual Local Area Network) composed of the same routing path;
a selection module, configured to choose one of the at least one Virtual LAN of each of the master router and the at least one backup router to be a communication representative;
a transmission module, configured to make the communication representative of the master router transmit an advertisement packet to that of each of the at least one backup router in a first time interval continuously and transmit an Address Resolution Protocol table to the at least one backup router in a second time interval continuously;
a redundancy module, configured to judge that all the Virtual LANs of the master router are abnormal and reselecting one of the at least one backup router to replace the master router according to the weight value of the at least one backup router when the advertisement packet transmitted from the master router is not received by the communication representative of the at least one backup router in a third time interval.

2. The redundancy system according to claim 1, wherein when the advertisement packet of the master router is received by the communication representative of the at least one backup router, the redundancy module further makes the selection module reselect the other communication representative or sustain to use the communication representative according to a parameter of the advertisement packet.

3. The redundancy system according to claim 1, wherein the preset first time interval is 25 milliseconds, the preset second time interval is 10 seconds and the preset third time interval is a multiple of the first time interval.

4. The redundancy system according to claim 1, wherein the selection of the master router and the backup router is determined by their weight values, and the master router is a router with a large weight value and the backup router is the one with a small weight value.

5. The redundancy system according to claim 1, wherein when a judgment for all the Virtual LANs of the master router is abnormal, the master router is replaced by the backup router with a largest weight value.

6. A redundancy method based on the Virtual Router Redundancy Protocol used for a plurality of routers in a network environmental, the redundancy method comprising steps of:
choosing a master router and at least one backup router from the routers, wherein the master router and the at least one backup router comprise a weight value and at least one Virtual LAN (Virtual Local Area Network) composed of the same routing path;
choosing one of the at least one Virtual LAN of each of the master router and the at least one backup router to be a communication representative;
transmitting an advertisement packet from the communication representative of the master router to that of the at least one backup router in a first time interval continuously and transmitting an Address Resolution Protocol table to the at least one backup router in a second time interval continuously; and
judging that all the virtual local area networks of the master router are abnormal and reselecting one of the at least one backup router to replace the master router according to the weight value thereof when the advertisement packet transmitted from the master router is not received by the communication representative of the at least one backup router in a third time interval.

7. The redundancy method according to claim 6, further comprising the step of making the selection module reselect the other communication representative or sustain to use the communication representative according to a parameter of the advertisement packet when the advertisement packet transmitted from the master router is received by the communication representative of the at least one backup router in the third time interval.

8. The redundancy method according to claim 6, wherein the preset first time interval is 25 milliseconds, the preset second time interval is 10 seconds and the preset third time interval is a multiple of the first time interval.

9. The redundancy method according to claim 6, wherein the selection of the master router and the backup router is determined by their weight values, and the master router is a router with a large weight value and the backup router is the one with a small weight value.

10. The redundancy method according to claim 6, wherein when a judgment for all the Virtual LANs of the master router is abnormal, the master router is replaced by the backup router with a largest weight value.
